(19) United States
(12) Patent Application Publication
(10) Pub. No.: US 2025/0031253 A1
(43) Pub. Date: Jan. 23, 2025

(54) METHOD AND DEVICE FOR OPTIMIZING CROSS SIM CALLING IN USER EQUIPMENT WITH MULTIPLE SIMS

(71) Applicant: Samsung Electronics Co., Ltd., Suwon-si (KR)

(72) Inventors: Madhusudan Gorur MANJUNATH, Bangalore (IN); Sunil Kumar Nagaraju, Bangalore (IN); Kaja Mohaideen Mohamed Ali, Bangalore (IN); Sreenivasa Dhamarangunta Reddy, Bangalore (IN); Anupam Majumder, Bangalore (IN)

(21) Appl. No.: 18/670,143

(22) Filed: May 21, 2024

Related U.S. Application Data
(63) Continuation of application No. PCT/KR2024/004272, filed on Apr. 2, 2024.

(30) Foreign Application Priority Data
Jul. 19, 2023 (IN) 202341048547

(51) Int. Cl. H04W 76/10; H04W 8/20; H04W 12/043; H04W 52/02

(52) U.S. Cl. CPC H04W 76/10; H04W 8/20; H04W 12/043; H04W 52/0261

(57) ABSTRACT

A method for optimizing cross Subscriber Identity Module (SIM) calling by a User Equipment (UE), comprising: detecting, by the UE, an event associated at the UE, and cross SIM calling is established at the UE; initiating, by the ePDG of the AP, an evolved Packet data gateway (ePDG) at a communication processor (CP) of the UE based on the call being established; and processing, by the CP of the UE, the cross SIM data packets using an IP security tunnel.

### CROSS-REFERENCE TO RELATED APPLICATIONS

This application is a continuation of International Application No. PCT/KR2024/004272 designating the United States, filed on Apr. 2, 2024, in the Korean Intellectual Property Receiving Office and claiming priority to Indian Complete patent application No. 202341048547, filed on Jul. 19, 2023, in the Indian Patent Office, the disclosures of each of which are incorporated by reference herein in their entireties.

### BACKGROUND

### Field

The disclosure relates to wireless communications, and for example, to optimizing cross SIM calling in a User Equipment (UE) with multiple Subscriber Identity Modules (SIM's).

### Description of Related Art

Generally, UE allow users to have multiple SIM's on a single device and enable a cross SIM calling (i.e., backup calling) to make calls using an out-of-service SIM. The UE establishes an ePDG (evolved packet data gateway) that resides in an Application Processor (AP) utilizing a mobile data of an active SIM. The IMS architecture of the UE allows connection to the operator's core network through the ePDG using an internet path (Wi-Fi or mobile data).

In the case of the cross SIM calling, although voice calls are established using the active SIM internet connection, the UE may rely on the AP Audio controller, due to its dependency on the PDG located in the AP. Therefore, the audio packets need to be transmitted from a Communication Processor (CP) to the AP through a socket connection, and keeping the AP awake until the call ends. The high power consumption in the cross SIM calling is primarily attributed to the exchange of media packets between the CP and AP, which requires both the CP and AP to remain awake throughout the call and involves additional kernel processing for data exchange. This continuous data transfer not only consumes significant power but also affects the device performance and introduces latency that impacts call quality. The UE has one transmitter and two receivers, resulting in increased battery consumption due to frequent switching between the first SIM and the second SIM for transmission of the media packets.

Currently, the exchange of media packets between the CP and AP, requires both processors to remain active throughout the call. Therefore, there is a need to address the aforementioned drawbacks and provide an alternative solution to reduce the higher power consumption in the cross SIM calling.

### SUMMARY

Embodiments of the disclosure may optimize cross SIM calling in a UE with multiple SIMs. The UE includes a master-slave ePDG in an AP and a CP.

Embodiments of the disclosure may eliminate transferring of the media packets between the AP and the CP during a call, to reduce power consumption and processing.

Embodiments of the disclosure may perform dynamic switching of packetization task from the ePDG at the AP to the ePDG at the CP or vice-versa depending on the nature of Voice Call technology (Voice over WiFi (VoWiFi) or Voice over (NR) (VONR)/Voice over LTE (VOLTE)) or the UE condition.

Embodiments of the disclosure may reduce power consumption of the cross SIM by splitting ePDG into a master ePDG and a slave ePDG and running the slave ePDG in the CP.

Embodiments of the disclosure may reduce latency by preforming encryption and decryption of audio packets at the CP to improve the call quality.

Embodiments of the disclosure may achieve low power consumption.

Embodiments of the disclosure may reduce latency of audio packets required for Virtual reality (VR), Augmented Reality (AR), and Holographic Calls over the Cross SIM.

Embodiments of the disclosure may extend battery life during the cross SIM calling along with latency and device performance improvements.

Accordingly example embodiments herein disclose a method for optimizing cross Subscriber Identity Module (SIM) calling by a user equipment (UE). The method includes: detecting, by an evolved packet data gateway (ePDG) of an Application Processor (AP), an event associated with a first SIM of a plurality of SIMs at the UE; detecting, by the ePDG of the AP, that cross SIM calling is enabled at the UE; establishing, by the ePDG of the AP, an IP security tunnel over cross SIM mobile data by the UE based on the event associated with the first SIM being detected; creating, by the ePDG of the AP, an ePDG at a communication processor (CP) of the UE to access an established IP security tunnel; establishing, a call at the UE; initiating, by the ePDG of the AP, the ePDG at the CP of the UE based on the call being established; receiving, by the ePDG of the CP, cross SIM data packets related to the call from a second SIM based on establishment of the IP security tunnel; and processing, by the ePDG of the CP at the UE, the cross SIM data packets through the IP security tunnel.

In an example embodiment, the method includes: establishing, by the ePDG at the AP of the UE, the IP security tunnel for the first SIM using mobile data of the second SIM; creating, by the ePDG at the AP of the UE, an ePDG at the CP based on successful establishment of the IP security tunnel over the second SIM; receiving, by the CP of the UE, the cross SIM data packets related to the call from the second SIM; and sending by the CP of the UE, the cross SIM data packets related to the call to the ePDG at the CP of the UE.

In an example embodiment, the method includes: encrypting or decrypting, by the ePDG at the CP of the UE, the cross SIM data packets related to the call; and sending, by the ePDG at the CP of the UE, the encrypted or decrypted cross SIM data packets related to the call received from the second SIM to a CP audio controller for rendering the call.

In an example embodiment, the method includes: receiving, by the ePDG at the CP of the UE, information about the IP security tunnel from the ePDG at the AP of the UE; receiving, by the ePDG at the CP of the UE, the cross SIM data packets related to the call from the second SIM matching with the received information about the IP security tunnel; detecting, by the ePDG at the CP of the UE, audio extensible stream protocol (ESP) packets related to a call from the cross SIM data packets based on the received information about the IP security tunnel, wherein the information about the IP security tunnel comprises IP security keys along with at least one of security descriptor protocol (SDP) IP details and port details of the call; and encrypting or decrypting, by the ePDG at the CP of the UE, the audio ESP packets related to call.

In an example embodiment, the method includes: the ePDG at the CP encrypting or decrypting the audio ESP packets related to the call from the cross SIM data packets using authentication and encryption data received from the ePDG at the AP.

Accordingly example embodiments herein disclose a UE for optimizing cross SIM calling. The UE includes: a plurality of SIMs, a memory comprising information about the plurality of SIMs, an application processor comprising at least one processor, comprising processing circuitry and an evolved packet data gateway (ePDG), and a communication processor (CP) comprising at least one processor comprising processing circuitry. The CP comprises an ePDG at the CP configured to be controlled by the ePDG at the AP of the UE. The ePDG at the AP is configured to: detect an event associated with a first SIM of the plurality of SIMs at the UE, detect the cross SIM calling enabled at the UE and establish an IP security tunnel over cross SIM mobile data by the UE based on the event associated with the first SIM being detected, cerate the ePDG at the CP of the UE to access established IP security tunnel; the ePDG at the AP configured to initiate the ePDG at the CP of the UE based on the call being established by a user, receive cross SIM data packets related to the call from a second SIM based on establishment of the IP security tunnel by the ePDG of the CP; and process the cross SIM data packets by the ePDG of the CP at the UE using the IP security tunnel.

Accordingly example embodiments, a method performed by a user equipment (UE) for cross subscriber identity module (SIM) calling is provided. The method comprises detecting, by the UE, an event associated with a first SIM of the UE, and establishing cross SIM calling for a second SIM of the UE, initiating, by an application processor (AP) of the UE, an evolved packet data gateway (ePDG) at a communication processor (CP) of the UE based on the cross SIM calling being established, receiving, by the ePDG of the CP, cross SIM data packets, and processing, by the CP of the UE, the cross SIM data packets.

Accordingly example embodiments, a user equipment (UE) for cross subscriber identity module (SIM) calling is provided. The UE comprises a plurality of SIMs including a first SIM and second SIM; memory comprising information about the plurality of SIMs; an application processor (AP), comprising at least one processing circuitry, including an evolved packet data gateway (ePDG); a communication processor (CP) comprising at least one processing circuitry. The CP comprises an ePDG configured to be controlled by the ePDG at the AP of the UE. The UE is configured to detect an event associated with the first SIM of the UE, and establish cross SIM calling for the second SIM of the UE. The AP is configured to initiate an evolved packet data gateway (ePDG) at the CP of the UE based on the cross SIM calling being established. The CP is configured to receive cross SIM data packets through the ePDG of the CP and process the cross SIM data packets.

Accordingly example embodiments, a non-transitory computer readable storage medium is provided. The non-transitory computer readable storage medium stores instructions that cause a user equipment (UE) to perform operations including detecting, by the UE, an event associated with a first SIM of the UE, and establishing cross SIM calling for a second SIM of the UE; and initiating, by an application processor (AP) of the UE, an evolved packet data gateway (ePDG) at a communication processor (CP) of the UE based on the cross SIM calling being established; receiving, by the ePDG of the CP, cross SIM data packets; and processing, by the CP of the UE, the cross SIM data packets.

These and other aspects of the various example embodiments herein will be better appreciated and understood when considered in conjunction with the following description and the accompanying drawings. It is understood, however, that the following descriptions, while indicating various example embodiments and numerous specific details thereof, are given by way of illustration and not of limitation. Many changes and modifications be made within the scope of the disclosure herein without departing from the spirit thereof, and the embodiments herein include all such modifications.

### BRIEF DESCRIPTION OF THE DRAWINGS

These and other features, aspects, and advantages of certain embodiments the present disclosure will be more apparent from the following detailed description, taken in conjunction with the accompanying drawings, throughout which like reference letters indicate corresponding parts in the various figures, in which:

FIG. 1 is a diagram illustrating a cross SIM calling architecture, according to the prior art;

FIG. 2 is a diagram illustrating a method of cross SIM calling, according to the prior art;

FIG. 3 is a block diagram illustrating an example configuration of a system for optimizing cross SIM calling by the UE, according to various embodiments;

FIG. 4 is a diagram illustrating an example implementation of the ePDG at the CP, according to various embodiments;

FIG. 5 is a signal flow diagram illustrating example cross SIM calling with the ePDG at the CP, according to various embodiments;

FIG. 6 is a signal flow diagram illustrating cross SIM calling with dynamic switching, according to various embodiments;

FIG. 7A and FIG. 7B are graphs illustrating a comparison of power consumption, according to various embodiments;

FIG. 8 is a flowchart illustrating an example method for optimizing cross SIM calling in the UE with multiple SIM's, according to various embodiments;

FIG. 9 is a flowchart illustrating an example method for optimizing cross SIM calling by the UE, according to various embodiments;

FIG. 10 is a flowchart illustrating an example method for receiving the cross SIM data packets related to the call by the UE, according to various embodiments; and

FIG. 11 is a flowchart illustrating an example method for encrypting or decrypting the cross SIM data packets related to the call by the ePDG, according to various embodiments.

### DETAILED DESCRIPTION

The various example embodiments herein and the various features and advantageous details thereof are explained more fully with reference to the accompanying drawings and detailed in the following description. Descriptions of well-known components and processing techniques may be omitted so as to not unnecessarily obscure the embodiments herein. The various example embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the disclosure herein.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and case of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by symbols of the related art, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by symbols of the related art, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words, such as first, second, third, or the like, to describe components/elements/steps is for the purposes of this description and should not be construed as sequential ordering/placement/occurrence unless specified otherwise.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Embodiments may be described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits of a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the disclosed method. Likewise, the blocks of the embodiments be physically combined into more complex blocks without departing from the scope of the disclosed method.

The accompanying drawings are used to help easily understand various technical features and it is understood that the various example embodiments presented herein are not limited by the accompanying drawings. As such, the disclosed method is understood to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

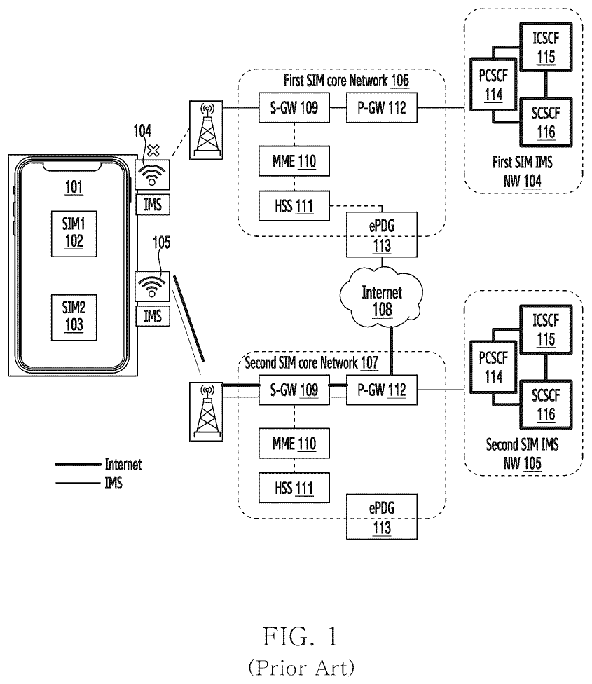

FIG. 1 is a diagram illustrating a cross SIM calling architecture, according to the prior art.

Referring to FIG. 1, the cross SIM calling architecture includes a UE (101), a first SIM (102), a second SIM (103), a first SIM IMS network (104), a second SIM IMS network (105), a first SIM core network (106), a second SIM core network (107) and an internet 108. The first SIM core network (106) includes a Serving Gateway (SGW) (109), a Mobility Management Entity (MME) (110), a Home Subscriber Server (111), a Packet Network Gateway (112), and an ePDG (113). The first SIM IMS network (104) includes a Proxy-Call Session Control Function (PCSCF) (114), an Interrogating Call Session Control Function (ICSCF) (115), and a Serving Call Session Control Function (SCSCF) (116). The second SIM core network (107) includes the SGW (109), the MME (110), the HSS (111), the PNG (112), and the ePDG (113). The second SIM IMS network (106) includes the PCSCF (114), the ICSCF (115), and the SCSCF (116).

The SGW (109) may be responsible for routing, forwarding, packet marking and buffering, user mobility management, and support for handover connections between the first SIM IMS network (104) and the second SIM IMS network (105). The MME (110) may be responsible for e.g. NAS layer signaling (Non Access Stratum), user authentication and authorization, support for connecting UE (101) to the first SIM IMS network (104) and/or the second SIM IMS network (105), setting and managing bearer, selection of PGW and SGW for a given connection, selection of a different MME when switching between eNodeB, TA (Tracking Area) management, and roaming support. The HSS (111) may be configured to manage user profiles, subscriptions and security functions. The HSS (111) may be responsible for user authentication when trying to connect to the first SIM IMS network (104) and/or the second SIM IMS network (105) and authorization of access to the selected services. The HSS (111) may be configured to store information about the user's location. The PNG (112) may be responsible for assigning IP addresses to terminals, filtering/inspecting packets, supporting selected functionalities in the first SIM IMS network (104) and/or the second SIM IMS network (105) and charging for their use. The ePDG (113) may be configured to secure the data transmission with the UE (101) connected to an Evolved Packet Core (EPC) over untrusted non-3GPP access, e.g. Voice over Wi-Fi (VoWi-Fi). For this purpose, the ePDG (113) acts as a termination node of IPsec tunnels established with the UE (101).

The PCSCF (114) may be performed by the UE (101) during IMS signaling flow establishment is supported by 5G Session Management Function (SMF). The ICSCF (115) may enable requests to be routed to the correct SCSCF (116). As there may be several SCSCFs either within the first SIM IMS network (104) and the second SIM IMS network (105), or if a roaming user requests access. The ICSCF (115) may interrogate the HSS (111) to obtain the address of the relevant SCSCF (116) to process the signaling protocol initiation request. The SCSCF (116) may be responsible for conducting both registration and session control for the registered UE's sessions. The SCSCF (116) functions as a registrar and enables the network location information of the UE (101) to be available at the HSS (111). The SCSCF (116) makes a determination to allow or deny service to the UE (101).

The cross SIM calling may be configured to enable a user to make call with an out of service (no signal coverage) SIM (For example, the first SIM (102)) by establishing the PDG (113) using the Mobile data of an alternative SIM (For example, the second SIM (103)) which has Mobile data service. The cross SIM calling may also be represented as Backup Calling. The ePDG (113) may reside in an AP of the UE (101). This is possible only for the IMS Calls as the IMS architecture allows the UE (101) to reach the operator's core network through the ePDG (113) at the AP using an internet path (Wi-Fi or Mobile Data).

In accordance to FIG. 1, the core network of the first SIM (102) is not reachable due to no signal coverage but the second SIM (103) has coverage, then the first SIM (102) may leverage the network of the second SIM (103) and connects to the core network of the first SIM (102) through the ePDG (113) at the AP of the first SIM (102).

As per the existing UE (101) design (or other OEMs who are having Wi-Fi Calling solution at AP), the VOWIFI calls uses an AP Audio controller (Wi-Fi and ePDG modules are in AP) and VOLTE calls uses a CP Audio controller (Modem is in CP).

In case of the cross SIM calling, though Voice call is established using the active (Mobile Data) SIM's Internet Connection (the second SIM), still the cross SIM calling uses the AP Audio controller due to dependency on the ePDG (113) which is in the AP, this requires multiple audio packets need to be transmitted from a CP to the AP through a socket connection which in turn keeps the AP awake till the call ends. This consumes lot of power as the AP needs to be awake throughout the call to process the Audio packets receiving from the CP.

The UE (101) performance may be hampered due to continuous data pump from the CP to the AP. The latency also increases which may impact the call quality (especially for XR calls, latency must be very low).

When one of the SIM cards goes out of service (OOS) (the first SIM (102) or the second SIM (103)) then the cross SIM calling gets applied automatically on the UE (101), but there are situations where the cross SIM calling is not enabled as listed below. For example, the network coverage of the first SIM (102) or the second SIM (103) is good but the calls are failing due to bearer issues. In another example, when the battery saving mode is enabled on the UE (101).

As shown in Power Consumption table, the power consumption of Cross SIM calling is ˜101 mAh higher when compared to the VOLTE Call for an hour Call duration.

TABLE I

| | Power Consumption (mAh) | | | |
|---|---|---|---|---|
| | Cross SIM | VoLTE | | Improvement |
| Call Type | Calling | call | Difference | (%) |
| Voice | 269.28 | 168.18 | 101.1 | 37.5% |
| Video | 810.42 | 617.53 | 192.89 | 23.8% |

The disclosed UE (101) may be configured to improve power consumption by 37.5% in voice calls and 23.8% in video calls.

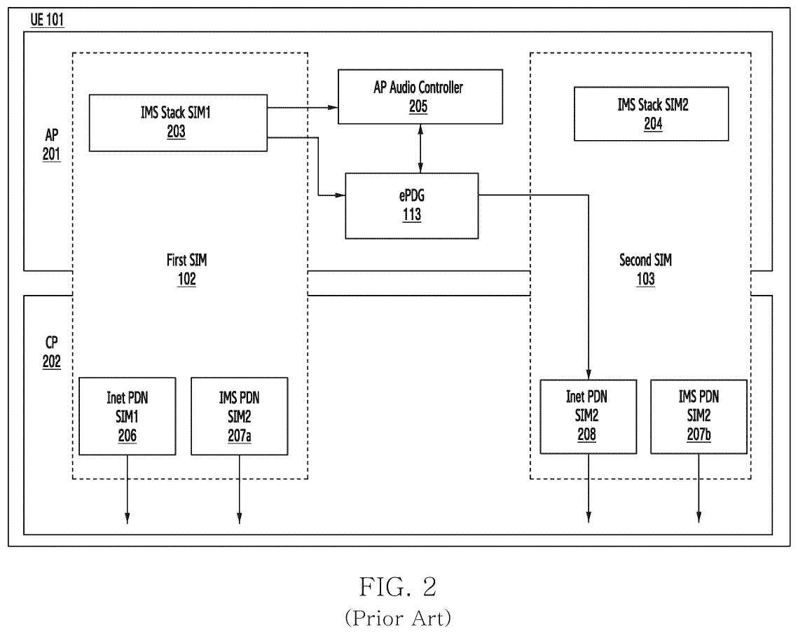

FIG. 2 is a diagram illustrating a method of cross SIM calling, according to the prior art.

Referring to FIG. 2, the method of cross SIM calling includes the UE (101), an AP (201), a CP (202), the first SIM (102), and the second SIM (103). The AP (201) includes a first SIM IMS stack (203), a second SIM IMS stack (204), and an AP Audio controller (205), the ePDG (113) at the AP (201). The CP (202) includes a first SIM internet PDN (206), a first IMS PDN (207a) of the second SIM (103), a second SIM internet PDN (208), and a second IMS PDN (207b) of the second SIM (103).

The AP (201) may be responsible for running Operating System (Android OS) on the UE (101). The AP (201) may be configured to establish the call and takes care of the Audio during the VoWiFi Call. The CP (202) may be responsible to handle wireless network communication (For example, 5G, LTE, 3G, and the like) by transmitting and receiving signals from a network. The CP (202) may be configured to take care of audio during Voice over NR/Voice over LTE (VONR/VOLTE) call.

The first SIM (102) on the UE (101) may be configured to initiate the call using the network or internet over the second SIM (103). The call may be a Voice (IMS) call includes real-time transport protocol (RTP) Packets (audio packets). The RTP Packets (audio packets) of the voice call related to the first SIM (102) may be received by the CP (202) from the second SIM Internet PDN (208).

Further, the audio packets may be transmitted from the CP (202) to the AP (201) which results in keeping the AP (201) awake throughout the call. The AP (201) may receive the audio packets and are delivered to the ePDG (113) at the AP (201). The ePDG (113) at the AP (201) may be configured to feed the audio packets to the AP Audio controller (205) at the AP (201). The first SIM IMS stack (203), and the second SIM IMS stack (204) may be configured to deliver communications services such as voice, video and text messaging over IP networks. The first SIM internet PDN (206) and the second SIM Internet PDN (208) connection may established between the UE (101) and the network to allow the UE (101) to access data services. The first IMS PDN (207a) and the second IMS PDN (207b) are the network architectures may integrate with the first SIM (102) and the second SIM (103) to enable IP-based real-time services, including traditional voice calls, text messages (SMS) and multimedia messages (MMS).

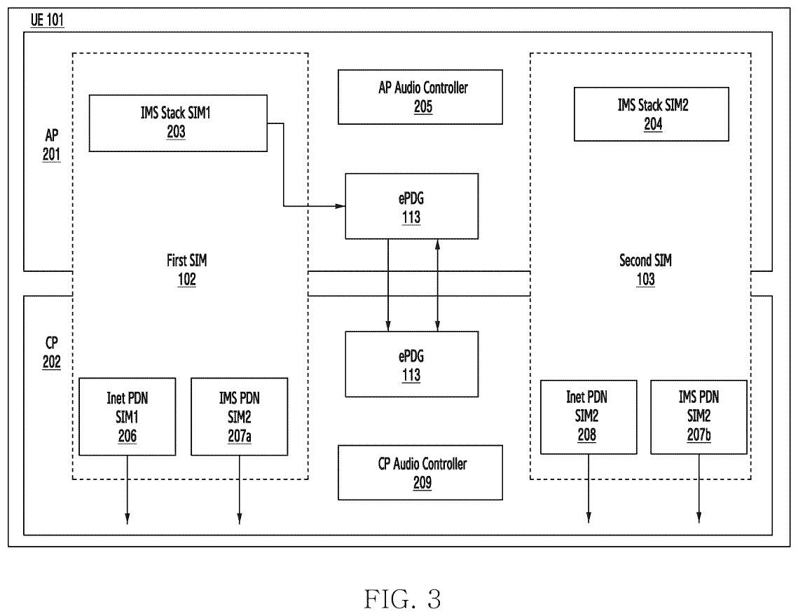

FIG. 3 is a block diagram illustrating an example configuration of a system for optimizing cross Subscriber Identity Module (SIM) calling by the User Equipment (UE), according to various embodiments.

Referring to FIG. 3, the system for optimizing cross Subscriber Identity Module (SIM) calling includes the UE (101), the AP (e.g., including processing circuitry) (201), the CP (e.g., including processing circuitry) (202), the first SIM (102), and the second SIM (103). The AP (201) includes the first SIM IMS stack (203), the second SIM IMS stack (204), and the AP Audio controller (205), the ePDG (113) at the AP (201). The CP (202) includes the first SIM internet PDN (206), the first IMS PDN (207a) of the second SIM (103), the second SIM internet PDN (208), and the second IMS PDN (207b) of the second SIM (103), the ePDG (113) at the CP 202, and a CP Audio controller (209). The processors, e.g., the AP and CP, may each include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the UE (101) may be configured to detect an event associated with the first SIM (102) of a multiple SIMs at the UE (101) when the cross SIM calling is enabled at the UE (102. The multiple SIMs may include two or more SIMs at the UE (101). The event may include, but is not limited to, a signal condition of the first SIM meets a signal condition threshold (e.g., the signal quality associated with the first SIM is lower than a signal quality threshold), a battery level of the UE meets a battery level threshold (e.g., the battery level of the UE is lower than the battery level threshold), and an enablement of a power saving at the UE, and the like. The ePDG (113) at the AP (201) may be configured to monitor for the signal level, once the signal level drops below the threshold, the ePDG (113) at the (AP) (201) over cross SIM gets initiate (Cross SIM calling is initiated). The ePDG (113) at the AP (201) of the UE (101) may be configured to establish an IP security tunnel over the cross SIM mobile data or network (e.g., over the mobile data or network of the second SIM (103)) when the event associated with the first SIM (102) is detected. The ePDG (113) at the AP (201) may be configured to create the ePDG (113) at the CP (202) to access the established IP security tunnel. The UE (101) may be configured to enable the user to initiate a call. The ePDG (113) at the AP (201) may be configured to initiate the ePDG (113) at the CP (202) once the call is established through the IP security tunnel. The ePDG (113) at the CP (202) may be configured to receive cross SIM data packets related to the call from a second SIM after establishment of the IP security tunnel. The cross SIM data packets may include, but not limited to, IP/PORT details, encryption and authentication keys, and the like. The ePDG (113) at the CP (202) of the UE (101) may be configured to process the cross SIM data packets through the IP security tunnel.

In an embodiment, the ePDG (113) at the AP (201) of the UE (101) may be configured to establish the IP security tunnel for the first SIM (102) using the mobile data of the second SIM (103). The ePDG (113) at the AP (201) of the UE (101) may be configured to retry for the IMS registration over the second SIM (103) if the IMS Registration is not success. The ePDG (113) at the AP (201) of the UE (101) may be configured to send a request to load the ePDG (113) at the CP (202) of the UE (101). The ePDG (113) at the AP (201) of the UE (101) may be configured to load the ePDG (113) at the CP (202) of the UE (101) upon successful IMS registration over the second SIM (103).

In an embodiment, the AP (201) of the UE (101) may be configured to send the cross SIM data packets related to the call to the CP (202) of the UE (101). The cross SIM data packets may include, but not limited to, IP/PORT details, encryption and authentication keys, and the like. The CP (202) of the UE (101) may be configured to receive cross SIM data packets related to the call from the second SIM (103) after establishment of the IP security tunnel. The CP (202) of the UE (101) may be configured to send the cross SIM data packets related to the call to the ePDG (113) at the CP (202).

The ePDG (113) at the CP (202) of the UE (101) may be configured to receive information about the IP security tunnel from the ePDG (113) at the AP (201) of the UE (101). The information about the IP security tunnel may include IP security keys along with at least one of SDP IP details and port details of the call. The ePDG (113) at the CP (202) of the UE (101) may be configured to receive the cross SIM data packets related to the call from the second SIM (103) matching with the received information about the IP security tunnel. The ePDG (113) at the CP (202) of the (UE) (101) may be configured to detect audio ESP packets related to call from the cross SIM data packets based on the received information about the IP security tunnel. The ePDG (113) at the CP (202) of the UE (101) may be configured to encrypt or decrypt the audio ESP packets related to call.

The ePDG (113) at the CP (202) of the UE (101) may be configured to send the encrypted or decrypted cross SIM data packets related to the call received from the second SIM (103) to the CP audio controller (209) for rendering the call. The CP (202) of the UE (101) may be configured to establish the call based on the cross SIM data packets received from the second SIM (103) using the IP security tunnel.

In an embodiment, the ePDG (113) at the CP (202) of the UE (101) may be configured to encrypt or decrypt the audio ESP packets related to call from the cross SIM data packets using authentication and encryption data received from the ePDG (113) at the AP (201). The authentication data may include, authentication algorithm and key. The encryption data may include encryption algorithm and key.

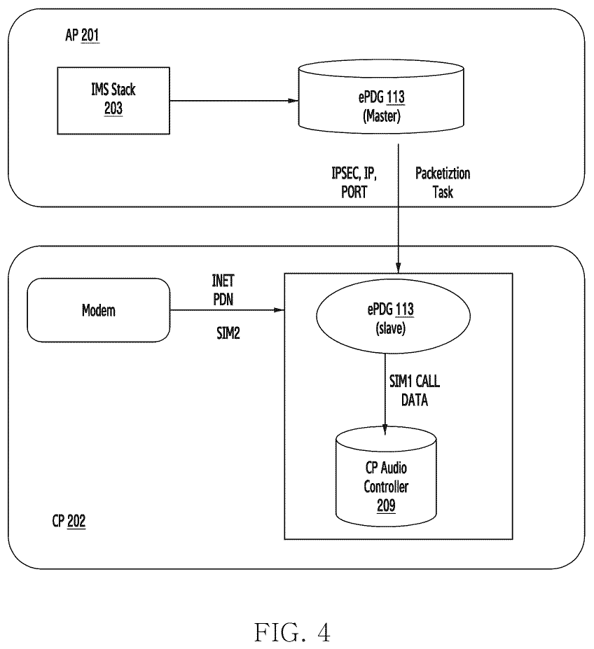

FIG. 4 is a diagram illustrating an example implementation of the ePDG (HotTunnel) (113) at the CP (202), according to various embodiments.

Referring to FIG. 4, the ePDG (HotTunnel) (113) at the CP (202) may be configured to decrypt or encrypt the cross SIM Audio packets. The ePDG (113) at the CP (202) may use open source ipsec libraries.

The first SIM IMS stack (203) indicates the ePDG (113) at the AP (201) about the call establishment. The ePDG (113) at the AP (201) (or the first SIM IMS stack (203)) sets the IPSEC & SDP IP/Port details to the ePDG (113) at the CP (202) through an IPC Communication. The ePDG (113) at the CP (202) may continuously monitors for the second SIM internet PDN (208), when the ePDG (113) at the CP (202) finds the matching ESP packets (based on IP/Port set by the ePDG main module) of the first SIM IMS Session then the ePDG (113) at the CP (202) decrypts the ESP packets and gives the RTP packets to the CP Audio controller (209). If the ESP packets are not related to the audio packets (For example, SIP or TCP packets) then the ePDG (113) at the CP (202) may notify the non-audio packets to the first SIM IMS stack (203) in the AP (201) directly.

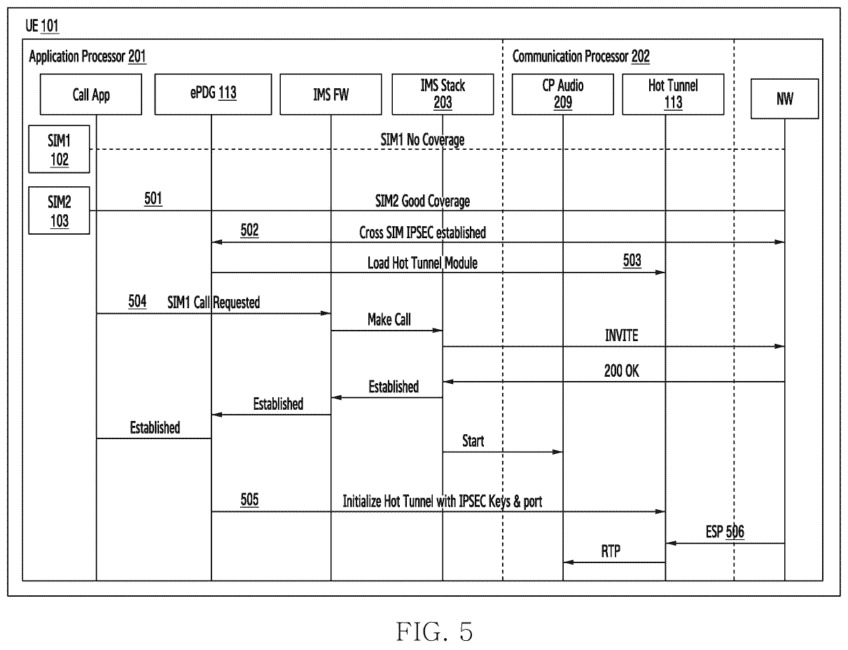

FIG. 5 is a signal flow diagram illustrating example cross SIM calling with the ePDG at the CP of the UE using the CP Audio controller, according to various embodiments.

At step 501, the cross SIM calling with the ePDG (113) at the CP (202) of the UE (101) includes the UE (101) may be configured to detect the first SIM (102) is Out of Service (OOS) and the second SIM (103) is in Good Coverage. The UE (101) may be configured to apply Cross SIM calling to the first SIM (102) as the first SIM (102) is out of service SIM.

At step 502, the ePDG (113) at the AP (201) of the UE (101) may be configured to establish IPSEC (Security tunnel) over cross SIM Mobile Data (the second SIM 103).

At step 503, the ePDG (113) at the AP (201) of the UE (101) may be configured to perform the IMS registration over cross SIM (the second SIM 103) upon successful establishment of the IPSEC tunnel. The AP (201) of the UE (101) may be configured to initiate or load the ePDG (113) at the CP (202).

At step 504, the user makes a call on the UE (101) and call session gets established.

At step 505, the AP (201) may be configured to sets the IPSEC details along with the call details to the ePDG (113) at the CP (202). The ePDG (113) at the CP (202) takes care of encryption of the audio packets coming from the CP Audio controller (209), and decryption of the ESP Audio Packets coming through the second SIM Internet PDN (208) and feeds the RTP packets to the CP Audio controller (209)

At step 506, the ePDG (113) at the CP (202) may be configured to decrypt the ESP packets and gives the audio packet to the CP Audio controller (209). If there are non-Audio ESP packets, then the non-Audio ESP packets are forwarded to the first SIM IMS Stack (203) of the AP (201) by the ePDG (113) at the CP (202).

In an embodiment, the ePDG (113) at the CP (202) is responsible for encryption of the Audio Packets coming from the CP Audio controller (209).

$$HotTunnel + Audio RTP Packet \text{=>} ESP Packet \qquad ( i )$$

The ePDG (113) at the CP (202) is responsible for decryption of the ESP Audio Packets coming from the second SIM (103).

$$HotTunnel + ESP Packet \text{=>} Audio RTP Packet \qquad ( ii )$$

The ePDG (113) at the CP (202) is responsible for forwarding the packets to the first SIM IMS Stack (203) of the AP (201) if the incoming packet is not an Audio packet.

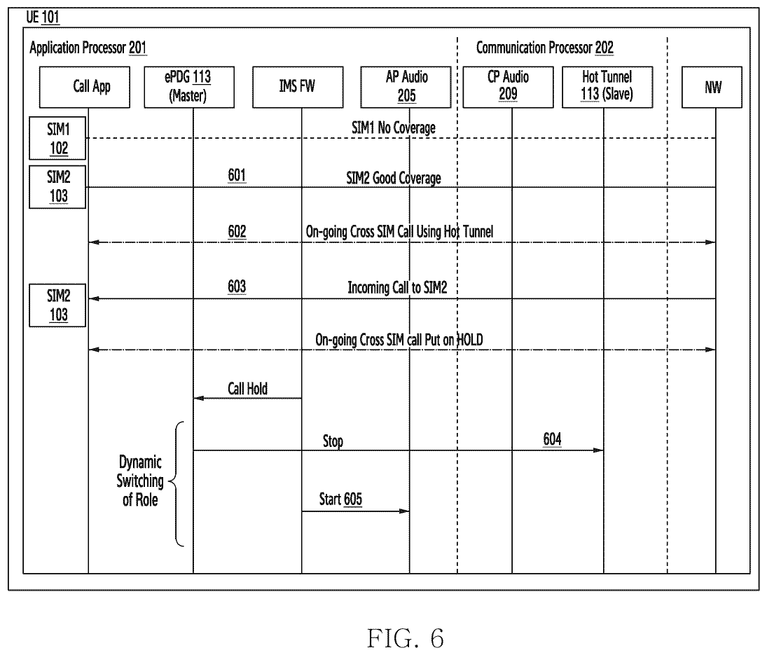

FIG. 6 is a signal flow diagram illustrating example cross SIM calling with dynamic switching between the ePDG (113) at the AP (201) and the ePDG (113) at the CP (202), according to various embodiments.

Referring to FIG. 6, At step 601, the first SIM (102) is Out of Service (OOS) and the second SIM (103) is in good coverage. Here, the cross SIM calling gets applied to the first SIM (102) as it is the Out of Service (OOS) SIM.

At step 602, the first SIM IMS is registered over the cross SIM (the second SIM 103) then the ePDG (113) at the AP (201) initiates (or loads) the ePDG (113) at the CP (202). The ePDG (113) at the AP (201) sets the IPSEC and PORT details to the ePDG (113) at the CP (201) when there is a call initiated by the user. The ePDG (113) at the CP (202) may be configured to take care of packetization role.

At step 603, the ePDG (113) at the AP (201) sends an indication to the ePDG (113) at the CP (202) to stop processing when a new call is received for the active SIM (the second SIM 103), as the CP Audio controller (209) need to be used for the new call.

At step 604, the ePDG (113) at the CP (202) stops listening to the ESP packets.

At step 605, the ePDG (113) at the AP (201) starts processing the ESP packets and gives it to/from the AP Audio controller (205).

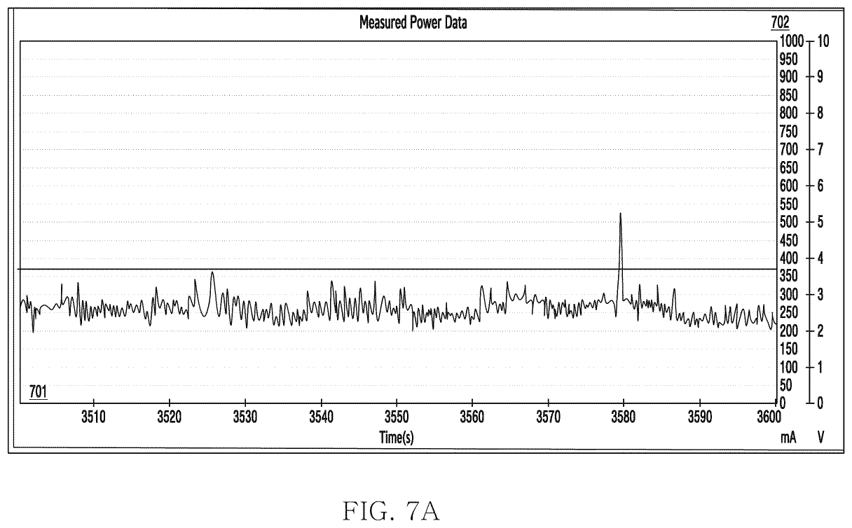

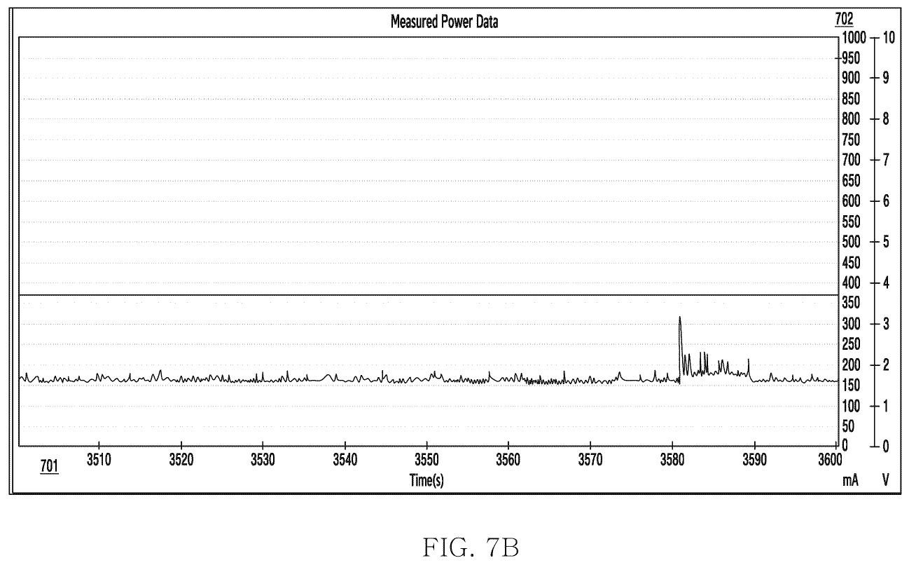

FIG. 7A and FIG. 7B are graphs illustrating a comparison of power consumption of the cross SIM calling with the ePDG (113) at the CP (202) and without the ePDG (113) at the CP (202), according to various embodiments.

Referring to FIG. 7A, the power consumption without the ePDG (113) at the CP (202). The diagram 700a depicts X-axis 701, and Y-axis 702. The X-axis 701 may be configured to represent time and the Y-axis 702 may be configured to represent the voltage. Though the cross SIM calling is very use full, but comes with a major drawback that it consumes lot of power (i.e., 1.6× times of VOLTE Call Power), Since the global market is going towards 5G which generally consumes higher power compared to LTE network, if the Cross SIM call is being made using 5G network then the battery consumption will be significantly high.

Power consumption in cross SIM calling is high due to the need of exchanging media packets between the CP (202) and the AP (201) which requires the CP (202) and the AP (201) to be awake throughout the call and also requires additional kernel processing in order to exchange data between the CP (202) and the AP (201).

$$Power Consumption = Same as VoWifi Call + AP ( 201 ) ⇔ CP ( 202 ) Data Exchange . \qquad ( i )$$

Referring to FIG. 7B, the power consumption with the ePDG (113) at the CP (202). The diagram 700a depicts X-axis 701, and Y-axis 702. The X-axis 701 may be configured to represent time and the Y-axis 702 may be configured to represent the voltage.

The ePDG (113) at the CP (202) may be configured to perform the responsibility assigned by ePDG (113) at the AP (201). The ePDG (113) at the CP (202) avoids media transfer between the AP (201) and the CP (202) during a call, thus helps to avoid power consumption and processing.

$$Power Consumption = Same as VoLTE Call + ePDG ( 113 ) at the CP ( 202 ) . \qquad ( ii )$$

The power consumption is less because only the CP (202) is awake. The power consumption of the ePDG (113) at the CP (202) is very less as the CP (202) only performs packetization. The ePDG (113) at the CP (202) may be configured to run on an advanced RISC machine hence the power consumption is less.

The power consumption is reduced by 37.5% (i.e ˜101 mAh) by establishing the ePDG (113) at the CP (202).

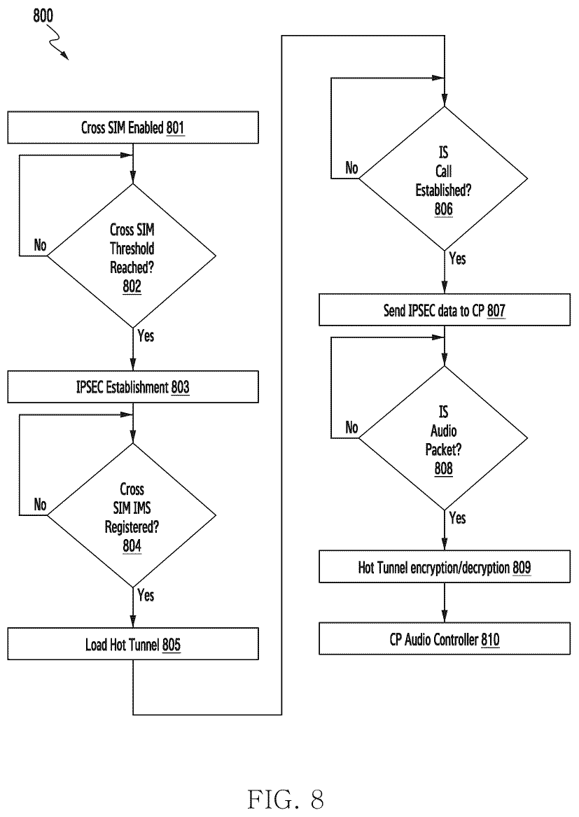

FIG. 8 is a flowchart (800) illustrating an example method for optimizing cross SIM calling in the user equipment with multiple SIM's, according to various embodiments.

At step (801), the method includes enabling cross SIM calling in the UE (101).

At step (802), the method includes monitoring for the signal level by the ePDG (113) at the AP (201), once the signal level drops below the threshold, the ePDG (113) at the AP (201) over cross SIM gets initiate (Cross SIM calling is initiated).

At step (803), the method includes establishing IPSEC (security tunnel) over the cross SIM mobile data (the second SIM 106).

At step (804), the method includes triggering the IMS Registration once the ePDG (113) at the AP (201) over the Cross SIM (the second SIM 103) is established, if the IMS Registration is not success, retrying for the IMS registration by the ePDG (113) at the AP (201).

At step (805), the method includes sending the request by the ePDG (113) at the AP (201) to load the ePDG (113) at the CP (202) once the IMS Registration is success over the cross SIM (the second SIM 103).

At step (806), the method includes initiating a call by the user and monitoring whether the call is established.

At step (807), the method includes sending IPSEC details (IP/PORT, encryption and authentication keys and algorithm) along with the SDP IP and port details of call session to the ePDG (113) at the CP (202) by the ePDG (113) at the AP (201) upon successful establishment of call. The method includes registering the ePDG (113) at the CP (202) with the CP (202) so that all the incoming data coming from the second SIM Internet PDN (208) matching with the specific IPSEC IP/PORT should be given to the ePDG (113) at the CP (202). The method includes filtering the incoming Audio ESP packets related to call by the ePDG (113) at the CP (202) using SDP IP/PORT details.

At step (808), the method includes determining whether the audio packets are detected or not.

At step (809), the method includes performing encryption/decryption of the Audio ESP packets by the ePDG (113) at the CP (202) using the authentication and encryption data given by the ePDG (113) at the AP (201).

At step (810), the method includes providing the decrypted Audio data to the CP Audio controller (209) by the ePDG (113) at the CP (202).

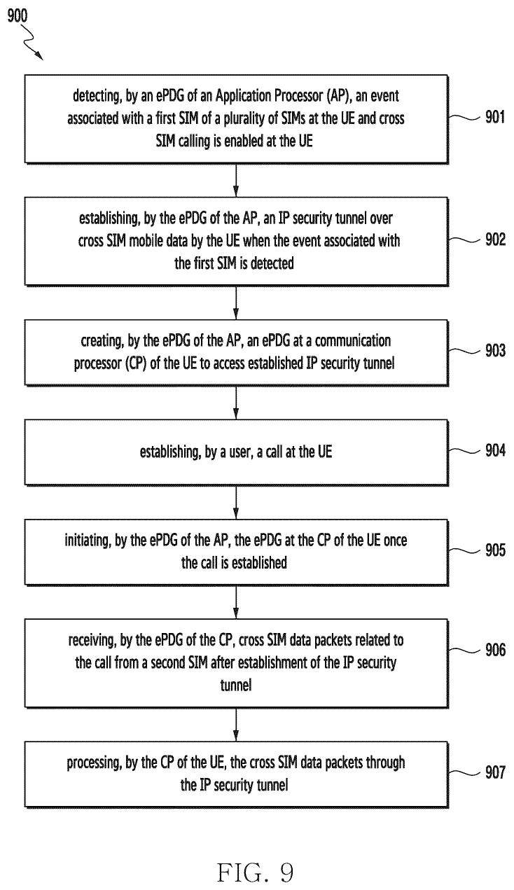

FIG. 9 is a flowchart (900) illustrating an example method for optimizing cross SIM calling by the UE, according to various embodiments.

At step (901), the method includes detecting the event associated with the first SIM (102) of the plurality of SIMs at the UE (101) by the ePDG (113) of the AP (201).

At step (901), the method includes detecting the cross SIM calling is enabled at the UE (101) by the ePDG (113) of the AP (201).

At step (902), the method includes establishing the IP security tunnel over cross SIM mobile data by the UE (101) when the event associated with the first SIM (102) is detected by the ePDG (113) of the AP (201).

At step (903), the method includes creating the ePDG (113) at the CP (202) of the UE (101) by the ePDG (113) of the AP (201) to access established IP security tunnel.

At step (904), the method includes establishing, by the user, the call at the UE (101).

At step (905), the method includes initiating, by the ePDG (113) of the AP (201), the ePDG (113) at the CP (202) of the UE (101) once the call is established.

At step (906), the method includes receiving cross SIM data packets related to the call by the ePDG (113) of the CP (202) from the second SIM (103) after establishment of the IP security tunnel.

At step (907), the method includes processing the cross SIM data packets by the PDG (113) of the CP (202) through the IP security tunnel.

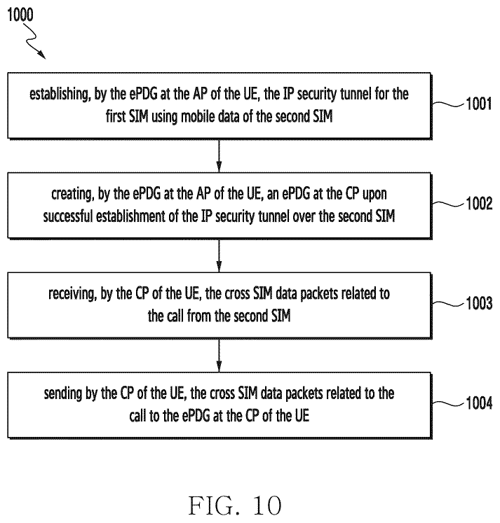

FIG. 10 is a flowchart (1000) illustrating an example method for receiving the cross SIM data packets related to the call by the UE, according to various embodiments.

At step (1001), the method includes establishing the IP security tunnel for first SIM (102) by the ePDG (113) at the AP (201) of the UE (101) using mobile data of second SIM (103).

At step (1002), the method includes creating the ePDG (113) at the CP (202) by the ePDG (113) at the AP (201) of the UE (101) upon successful establishment of the IP security tunnel over the second SIM (103).

At step (1003), the method includes receiving the cross SIM data packets related to the call by the CP (202) of the UE (101) from the second SIM (103).

At step (1004), the method includes sending the cross SIM data packets related to the call to the ePDG (113) at the CP (202) of the UE (101) by the CP (202) of the UE (101).

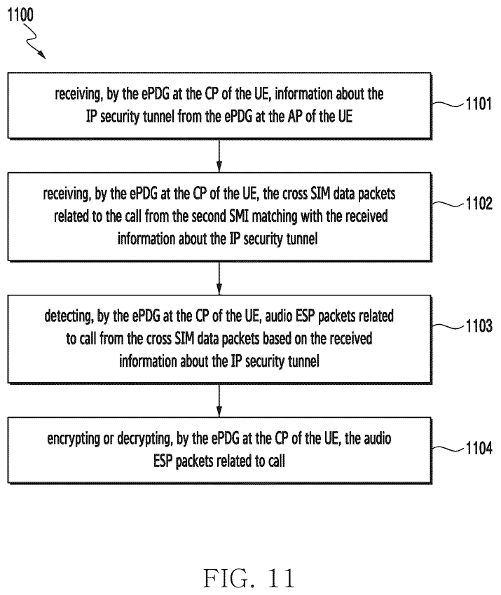

FIG. 11 is a flowchart (1100) illustrating an example method for encrypting or decrypting the cross SIM data packets related to the call by the ePDG at the CP, according to various embodiments.

At step (1101), the method includes receiving information about the IP security tunnel from the ePDG (113) at the AP (201) of the UE (101) by the ePDG (113) at the communication processor CP (202) of the UE (101).

At step (1102), the method includes receiving the cross SIM data packets related to the call by the ePDG (113) at the CP (202) of the UE (101) from the second SIM (103) matching with the received information about the IP security tunnel.

At step (1103), the method includes detecting audio ESP packets related to call by the ePDG (113) at the CP (202) of the UE (101) from the cross SIM data packets based on the received information about the IP security tunnel.

At step (1104), the method includes encrypting or decrypting the audio ESP packets related to call by the ePDG (113) at the CP (202) of the UE (101).

According to embodiments, a method performed by a user equipment (UE) for cross subscriber identity module (SIM) calling is provided. The method comprises detecting, by the UE, an event associated with a first SIM of the UE, and establishing cross SIM calling for a second SIM of the UE, initiating, by an application processor (AP) of the UE, an evolved packet data gateway (ePDG) at a communication processor (CP) of the UE based on the cross SIM calling being established, receiving, by the ePDG of the CP, cross SIM data packets, and processing, by the CP of the UE, the cross SIM data packets.

In an example, the establishing the cross SIM calling comprises establishing, by an ePDG of the AP, an internet protocol (IP) security tunnel for the first SIM using mobile data of the second SIM based on the event; and creating, by the ePDG of the AP, the ePDG at the CP of the UE to access established IP security tunnel based on successful establishment of the IP security tunnel over the second SIM.

In an example, the receiving, by the ePDG of the CP, the cross SIM data packets comprises receiving, by the CP of the UE, the cross SIM data packets related to a call from the second SIM; and sending, by the CP of the UE, the cross SIM data packets related to the call to the ePDG at the CP of the UE.

In an example, the processing the cross SIM data packets comprises encrypting and/or decrypting, by the ePDG at the CP of the UE, the cross SIM data packets related to a call received from the second SIM; and sending, by the ePDG at the CP of the UE, the encrypted or decrypted cross SIM data packets related to the call received from the second SIM to a CP audio controller for rendering the call.

In an example, the encrypting and/or decrypting the cross SIM data packets related to the call at the ePDG at the CP comprises receiving, by the ePDG at the CP of the UE, information about the IP security tunnel from the ePDG at the AP of the UE; receiving, by the ePDG at the CP of the UE, the cross SIM data packets related to the call from the second SIM matching received information about the IP security tunnel; detecting, by the ePDG at the CP of the UE, audio extensible stream protocol (ESP) packets related to the call from the cross SIM data packets based on the received information about the IP security tunnel; and encrypting and/or decrypting, by the ePDG at the CP of the UE, the audio ESP packets related to the call.

In an example, the encrypting and/or decrypting the audio ESP packets related to the call from the cross SIM data packets by the ePDG at the CP uses authentication and encryption data received from the ePDG at the AP.

In an example, the information about the IP security tunnel comprises IP security keys and at least one of security descriptor protocol (SDP) IP details and port details of the call.

In an example, the event comprises at least one of a signal quality of the first SIM being lower than a signal quality threshold, a battery level of the UE being lower than a battery level threshold, and an enabling of a power saving at the UE.

According to embodiments, a user equipment (UE) for cross subscriber identity module (SIM) calling is provided. The UE comprises a plurality of SIMs including a first SIM and second SIM; memory comprising information about the plurality of SIMs; an application processor (AP), comprising at least one processing circuitry, including an evolved packet data gateway (ePDG); a communication processor (CP) comprising at least one processing circuitry. The CP comprises an ePDG configured to be controlled by the ePDG at the AP of the UE. The UE is configured to detect an event associated with the first SIM of the UE, and establish cross SIM calling for the second SIM of the UE. The AP is configured to initiate an evolved packet data gateway (ePDG) at the CP of the UE based on the cross SIM calling being established. The CP is configured to receive cross SIM data packets through the ePDG of the CP and process the cross SIM data packets.

In an example, the UE is configured to establish, by the ePDG of the AP, an internet protocol (IP) security tunnel for the first SIM using mobile data of the second SIM based on the event; and create, by the ePDG of the AP, the ePDG at the CP of the UE to access established IP security tunnel based on successful establishment of the IP security tunnel over the second SIM.

In an example, the CP of the UE is configured to receive, by the CP of the UE, the cross SIM data packets related to a call from the second SIM; and send, by the CP of the UE, the cross SIM data packets related to the call to the ePDG at the CP of the UE.

In an example, the CP of the UE is configured to encrypt and/or decrypt, by the ePDG at the CP of the UE, the cross SIM data packets related to a call received from the second SIM, and send, by the ePDG at the CP of the UE, encrypted and/or decrypted cross SIM data packets related to the call received from the second SIM to a CP audio controller for rendering the call.

In an example, the CP of the UE is configured to receive, by the ePDG at the CP of the UE, the information about the IP security tunnel from the ePDG at the AP of the UE, receive, by the ePDG at the CP of the UE; the cross SIM data packets related to the call from the second SIM matching with received information about the IP security tunnel; detect, by the ePDG at the CP of the UE, audio extensible stream protocol (ESP) packets related to call from the cross SIM data packets based on the received information about the IP security tunnel; and encrypt and/or decrypt, by the ePDG at the CP of the UE, the audio ESP packets related to the call.

In an example, the ePDG at the CP is configured to encrypt and/or decrypt the audio ESP packets related to the call from the cross SIM data packets using authentication and encryption data received from the ePDG at the AP.

In an example, the information about the IP security tunnel comprises IP security keys and at least one of security descriptor (SD)P IP details and port details of the call.

In an example, the event comprises at least one of a signal quality of the first SIM being lower than a signal quality threshold, a battery level of the UE being lower than a battery level threshold, and an enablement of a power saving at the UE.

According to embodiments, a non-transitory computer readable storage medium is provided. The non-transitory computer readable storage medium stores instructions that cause a user equipment (UE) to perform operations including detecting, by the UE, an event associated with a first SIM of the UE, and establishing cross SIM calling for a second SIM of the UE; and initiating, by an application processor (AP) of the UE, an evolved packet data gateway (ePDG) at a communication processor (CP) of the UE based on the cross SIM calling being established; receiving, by the ePDG of the CP, cross SIM data packets; and processing, by the CP of the UE, the cross SIM data packets.

In an example, the instructions cause the UE to establish, by an ePDG of the AP, an internet protocol (IP) security tunnel for the first SIM using mobile data of the second SIM based on the event; and creating, by the ePDG of the AP, the ePDG at the CP of the UE to access established IP security tunnel based on successful establishment of the IP security tunnel over the second SIM.

In an example, the instructions cause the UE to encrypt and/or decrypt, by the ePDG at the CP of the UE, the cross SIM data packets related to a call received from the second SIM; and send, by the ePDG at the CP of the UE, the encrypted or decrypted cross SIM data packets related to the call received from the second SIM to a CP audio controller for rendering the call.

In an example, the event comprises at least one of a signal quality of the first SIM being lower than a signal quality threshold, a battery level of the UE being lower than a battery level threshold, and an enabling of a power saving at the UE.

The various actions, acts, blocks, steps, or the like in the method is performed in the order presented, in a different order or simultaneously. Further, in various embodiments, some of the actions, acts, blocks, steps, or the like may be omitted, added, modified, skipped, or the like without departing from the scope of the disclosed method.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method performed by a user equipment (UE) for cross subscriber identity module (SIM) calling, comprising:
detecting, by the UE, an event associated with a first SIM of the UE, and establishing cross SIM calling for a second SIM of the UE;
initiating, by an application processor (AP) of the UE, an evolved packet data gateway (ePDG) at a communication processor (CP) of the UE based on the cross SIM calling being established;
receiving, by the ePDG of the CP, cross SIM data packets; and
processing, by the CP of the UE, the cross SIM data packets.

2. The method of claim 1, wherein the establishing the cross SIM calling comprises:
establishing, by an ePDG of the AP, an internet protocol (IP) security tunnel for the first SIM using mobile data of the second SIM based on the event; and
creating, by the ePDG of the AP, the ePDG at the CP of the UE to access established IP security tunnel based on successful establishment of the IP security tunnel over the second SIM.

3. The method of claim 1, wherein the receiving, by the ePDG of the CP, the cross SIM data packets comprises:
receiving, by the CP of the UE, the cross SIM data packets related to a call from the second SIM; and
sending, by the CP of the UE, the cross SIM data packets related to the call to the ePDG at the CP of the UE.

4. The method of claim 1, wherein the processing the cross SIM data packets comprises:
encrypting and/or decrypting, by the ePDG at the CP of the UE, the cross SIM data packets related to a call received from the second SIM; and
sending, by the ePDG at the CP of the UE, the encrypted or decrypted cross SIM data packets related to the call received from the second SIM to a CP audio controller for rendering the call.

5. The method of claim 4, wherein the encrypting and/or decrypting the cross SIM data packets related to the call at the ePDG at the CP comprises:
receiving, by the ePDG at the CP of the UE, information about the IP security tunnel from the ePDG at the AP of the UE;
receiving, by the ePDG at the CP of the UE, the cross SIM data packets related to the call from the second SIM matching received information about the IP security tunnel;
detecting, by the ePDG at the CP of the UE, audio extensible stream protocol (ESP) packets related to the call from the cross SIM data packets based on the received information about the IP security tunnel; and
encrypting and/or decrypting, by the ePDG at the CP of the UE, the audio ESP packets related to the call.

6. The method of claim 5, wherein the encrypting and/or decrypting the audio ESP packets related to the call from the cross SIM data packets by the ePDG at the CP uses authentication and encryption data received from the ePDG at the AP.

7. The method of claim 5, wherein the information about the IP security tunnel comprises IP security keys and at least one of security descriptor protocol (SDP) IP details and port details of the call.

8. The method of claim 1, wherein the event comprises at least one of a signal quality of the first SIM being lower than a signal quality threshold, a battery level of the UE being lower than a battery level threshold, and an enabling of a power saving at the UE.

9. A user equipment (UE) for cross subscriber identity module (SIM) calling, comprising:
a plurality of SIMs including a first SIM and second SIM;
memory comprising information about the plurality of SIMs;
an application processor (AP), comprising at least one processing circuitry, including an evolved packet data gateway (ePDG);
a communication processor (CP) comprising at least one processing circuitry;
wherein the CP comprises an ePDG configured to be controlled by the ePDG at the AP of the UE,
wherein the UE is configured to detect an event associated with the first SIM of the UE, and establish cross SIM calling for the second SIM of the UE,
wherein the AP is configured to initiate an evolved packet data gateway (ePDG) at the CP of the UE based on the cross SIM calling being established; and
wherein the CP is configured to receive cross SIM data packets through the ePDG of the CP and process the cross SIM data packets.

10. The UE of claim 9, wherein the UE is configured to:
establish, by the ePDG of the AP, an internet protocol (IP) security tunnel for the first SIM using mobile data of the second SIM based on the event; and
create, by the ePDG of the AP, the ePDG at the CP of the UE to access established IP security tunnel based on successful establishment of the IP security tunnel over the second SIM.

11. The UE of claim 9, wherein the CP of the UE is configured to:
receive, by the CP of the UE, the cross SIM data packets related to a call from the second SIM; and
send, by the CP of the UE, the cross SIM data packets related to the call to the ePDG at the CP of the UE.

12. The UE of claim 9, wherein the CP of the UE is configured to:
encrypt and/or decrypt, by the ePDG at the CP of the UE, the cross SIM data packets related to a call received from the second SIM, and
send, by the ePDG at the CP of the UE, encrypted and/or decrypted cross SIM data packets related to the call received from the second SIM to a CP audio controller for rendering the call.

13. The UE of claim 12, wherein the CP of the UE is configured to:
receive, by the ePDG at the CP of the UE, the information about the IP security tunnel from the ePDG at the AP of the UE;
receive, by the ePDG at the CP of the UE, the cross SIM data packets related to the call from the second SIM matching with received information about the IP security tunnel;
detect, by the ePDG at the CP of the UE, audio extensible stream protocol (ESP) packets related to call from the cross SIM data packets based on the received information about the IP security tunnel; and
encrypt and/or decrypt, by the ePDG at the CP of the UE, the audio ESP packets related to the call.

14. The UE of claim 13, wherein the ePDG at the CP is configured to encrypt and/or decrypt the audio ESP packets related to the call from the cross SIM data packets using authentication and encryption data received from the ePDG at the AP.

15. The UE of claim 13, wherein the information about the IP security tunnel comprises IP security keys and at least one of security descriptor (SD)P IP details and port details of the call.

16. The UE of claim 9, wherein the event comprises at least one of a signal quality of the first SIM being lower than a signal quality threshold, a battery level of the UE being lower than a battery level threshold, and an enablement of a power saving at the UE.

17. A non-transitory computer-readable storage medium storing instructions that cause a user equipment (UE) to perform operations including:
detecting, by an application processor (AP) of the UE, an event associated with a first SIM of the UE, and establishing cross SIM calling for a second SIM of the UE; and
initiating, by the AP of the UE, an evolved packet data gateway (ePDG) at a communication processor (CP) of the UE based on the cross SIM calling being established;
receiving, by the CP, cross SIM data packets through the ePDG of the CP; and
processing, by the CP of the UE, the cross SIM data packets.

18. The non-transitory computer-readable storage medium of claim 17, wherein the instructions cause the UE to:
establish, by an ePDG of the AP, an internet protocol (IP) security tunnel for the first SIM using mobile data of the second SIM based on the event; and
creating, by the ePDG of the AP, the ePDG at the CP of the UE to access established IP security tunnel based on successful establishment of the IP security tunnel over the second SIM.

19. The non-transitory computer-readable storage medium of claim 17, wherein the instructions cause the UE to:
encrypt and/or decrypt, by the ePDG at the CP of the UE, the cross SIM data packets related to a call received from the second SIM; and
send, by the ePDG at the CP of the UE, the encrypted or decrypted cross SIM data packets related to the call received from the second SIM to a CP audio controller for rendering the call.

20. The non-transitory computer-readable storage medium of claim 17, wherein the event comprises at least one of a signal quality of the first SIM being lower than a signal quality threshold, a battery level of the UE being lower than a battery level threshold, and an enabling of a power saving at the UE.
